(19) United States
(12) Patent Application Publication
(10) Pub. No.: US 2024/0265360 A1
(43) Pub. Date: Aug. 8, 2024

(54) METHOD AND SYSTEM FOR PROVIDING A RESPONSE TO A CLIENT REQUEST AND A SYSTEM FOR A CHAT CONVERSATION

(71) Applicant: Supertab AG, Steinhausen (CH)

(72) Inventor: Cosmin-Gabriel Ene, Munich (DE)

(21) Appl. No.: 18/430,051

(22) Filed: Feb. 1, 2024

(30) Foreign Application Priority Data
Feb. 3, 2023 (IE) S2023/0020

(51) Int. Cl. G06Q 20/10; G06Q 50/06

(52) U.S. Cl. CPC G06Q 20/102; G06Q 50/06

(57) ABSTRACT

A computer-implemented method for providing a response to a client request includes the steps of: receiving a client request over an interface from a client device; determining a client identity of a user issuing the request and/or the client device; determining costs for responding to the request, as a function of electrical power consumption by a trained artificial model; transmitting a cost indication to the client device based on the determined costs; determining the response to the client request using the trained artificial intelligence model; transmitting the response to the client device; allocating an amount to be paid for the transmission of the response, with or without concurrently requiring payment of the amount, using the client identity, wherein the amount is based at least in part on the cost indication; monitoring a total allocated amount associated with the client identity; and transmitting a payment request, the payment request for at least partially settling the total allocated amount associated with the client identity when the total allocated amount exceeds a predetermined threshold amount.

### CROSS-REFERENCE TO RELATED APPLICATIONS

This application is based on and claims priority from Irish Patent Application No. S2023/0020 filed on Feb. 3, 2023.

### FIELD OF THE INVENTION

The invention relates to a method for providing a response to a client request and a system for providing a chat conversation.

### BACKGROUND OF THE INVENTION

Systems for providing online chat conversations are known. In the recent years, it has been becoming increasingly popular to have chatbots or chatter bots which participate in chats conducted between human beings. In the recent years, there has been a development in the service sector to use chatbots for responding to customer requests, e.g., to answer simple questions about pricing, service conditions and so forth. The respective chatbots serve to reduce the workload on human service persons and filter out the most basic questions so that the human beings can respond to more complicated and sophisticated questions.

With the increasing progress that has been made with trained models like neural networks and others, the capability of so-called chatbots to respond to more complex questions increased. In November 2022, Open AI launched Chat Generative Pre-Trained Transformer, also known as ChatGPT. ChatGPT provides a chatbot that uses an autoregressive language model generated by deep learning to produce humanlike text. With the respective software, the technology has shifted from the field of responding to predefined questions into an area where longer texts can be generated.

For providing sophisticated answers and generating text, applications like ChatGPT require massive calculation power and therefore consume an excessive amount of energy. Therefore, there is an increasing need to provide economically sensible approaches to coordinate the use of such systems.

There are approaches available to monetarize consumed calculation power including, for example, Microsoft Corporation's online pricing calculator, azure.microsoft.com/en-us/pricing/calculator/. However, these approaches do not provide incentives which lead to a load distribution.

Accordingly, it is an objective of the present application to provide an improved method for providing the responses to client requests. In particular, the method should allow the usage of resources effectively. Furthermore, an adequate usability should be ensured.

### SUMMARY OF THE INVENTION

The present invention solves the respective problem by a method and system for providing a response to a client request by at least one processor executing the steps of:
a) Receiving a client request over an interface from a client device;
b) Determining a client identity of a user issuing the request and/or the client device;
c) Determining cost for responding to the request by, for example, the forecast calculation as a function of electrical power consumption by the trained artificial intelligence model;
d) Transmitting a cost indication to the client device based on the determined costs;
e) Calculating a response to the client request using a trained artificial intelligence algorithm (“AI”) model, such as an autoregressive language model, and/or a deep learning model;
f) Transmitting the response to the client device;
g) Allocating an amount to be paid for the transmission of the response, with or without concurrently requiring payment of the amount, using the client identity, wherein the amount is based at least in part on the cost indication as described in paragraph [00012];
h) Monitoring a total allocated amount associated with the client identity;
i) Transmitting a payment request, the payment request for at least partially settling the total allocated amount associated with the client identity when the total allocated amount exceeds a (predetermined) threshold amount.

The request from the client can comprise an image, a text and/or audio/video data. Correspondingly, the response can be a text, an image or an audio/video data. The received client request can be a client request that is generated, e.g., via a web interface as it is common in chat programs. Alternatively, the respective request can be generated by any other means, e.g., by a word processing software like MICROSOFT WORD, a drawing program, a software running in a car or any other type of device.

In one embodiment, the disclosed method and/or system may determine the cost in step c based at least in part on a forecast calculation of at least one of estimated or required electrical power for the trained artificial intelligence model to determine at least one of (i) a response to the request, and (ii) a partial response to the client request;

In another embodiment, the disclosed method and/or system may be accessible via devices used for establishing an augmented reality. For example, questions can be generated interactively by pointing towards real life objects (e.g., “What is this?”) and answers can be augmented via the respective device. For example, respective glasses add text to the pointed out object showing the answer as generated by the response. Also, the method or the corresponding system can be accessible through a virtual reality. For instance, the client request can be generated while being in a virtual reality and/or based on any interaction with the virtual reality. In one embodiment, existing virtual worlds can be enhanced by providing interaction with the trained model, e.g., by improved navigation “Take me to the oldest building in this world.” or generative actions “Please add a room which fits the era of Napoleon.”

In the disclosed embodiments, the determining of a client identity is necessary to link the allocated amounts to a particular user, e.g., a participant in a chat, and/or a client device. For the present invention it is not necessary to identify the person as long as there is some indicator that links to the respective person or her/his user device. Also it is not necessary to receive much information from the particular user, e.g., via registration process. To identify the client device and/or the user, any type of hardware identification number can be used such as a MAC address (Media-Access-Control) and/or a processor identification number and/or a hard disk identification number and/or an IP address and/or other unique device numbers, such as the unique device identifier (UDID) of a smartphone. Also modern communication protocols provide access to mechanisms which allow identifying users and/or client devices. Such mechanisms can also be used to arrive at a client identity. The client identity can be any type of number or character and must not necessarily be unique to a single device and/or a single user. Some methods which can be used to establish a client identity in accordance with the inventive concept are discussed in WO2021259608 A1, which is incorporated in its entirety by reference herein.

For the benefits of the inventive method, it is a prerequisite that the response to the client request is generated/calculated using a trained model. Usually, applying such models is memory and calculation power extensive. Preferred AI models for accurate responses are autoregressive language models like deep learning models.

In accordance with one aspect of the invention, the generating of the response is linked to the allocation of an amount to be paid. In accordance with the invention, the amount does not need to be paid immediately. The debt is only noted and allows an immediate progressing of the process.

A payment will only be required if the summed up amount reaches a certain threshold value and/or has not been paid for a longer time period, e.g., within a month or two weeks.

By combining the concept of micropayments and/or fractional payments with the technology of chat bots, a very efficient approach to generating responses is achieved. While the micropayments or fractional payments do not constitute a significant hurdle to use the provided service, it filters the amount of requests and allows reducing the load on the servers that implement the method.

In accordance with the invention a fractional payment can be defined as a payment wherein the amount to be paid is a fraction of the smallest physical unit available in an official currency, e.g., a quarter of a Euro Cent.

In one embodiment, the method comprises the step of receiving an authorization signal, the authorization signal indicates that the user of the client device is accepting to allocate an amount that correlates to the cost indication for receiving the response to the client request. In one embodiment, the user will be informed about potential costs that will be generated and asked to compensate the respective costs. In accordance with another embodiment of the invention, an authorization for the respective costs is required. In a further embodiment, a response is only provided if a respective authorization is present.

In one embodiment, the step of transmitting a response to the client device comprises transmitting a first part of the response and transmitting at least a second part of the response. In other words, the response can be split-up or separated into several parts. In the respective embodiment, it is possible to transmit the second part of the response and any further parts only, if the authorization signal as already discussed is received. Transmitting the first part of the response prior to authorizing costs allows the user to decide whether the received information has such a value so that the respective costs are justified.

In one embodiment, the method may further comprise:
k) receiving a further client request over the interface from the client device and
l) determining whether a further authorisation signal is received, the further authorisation signal indicating that the user of the client device is accepting to allocate a further amount for a further response;
m) transmitting a further response to the client device, only if it is determined in step 1) that the authorisation signal has been received.

In another embodiment, the method may further comprise:
n) issuing at least one invitation message offering a reward for feedback on the provided receiving a message from the client device,
o) receiving a feedback message from the client device on the response as transmitted to the client device;
p) using the feedback message to train the trained model;
q) reducing the allocated amount to be paid in response to receiving the feedback message.

In one embodiment, the offering of a reward for the feedback is based on a static amount, e.g., 5 Cents, 10 Cents or 1 Euro.

In yet another embodiment, the offer can be dynamic, e.g., depending on how much the trained model would benefit from the feedback or how long and/or adequate the feedback is.

In one embodiment, the offered reward can be linked to a number of questions that the user is willing to answer.

Similarly, the invitation message can describe the algorithm according to which the reward is calculated or provide a tangible value. Alternatively, the invitation message can simply state that there will be a reward and the reward is calculated once the feedback is received. According to this, the allocated amount associated with the particular user and/or client device is reduced in response to receiving the feedback message. Again, the amount can be calculated at the time of the reduction or a flat rate can be reduced.

Thereby the micropayment and/or fractional payment system generates an incentive to improve the trained model. Furthermore, the incentive can be designed such that a feedback is collected with that data that is most needed to improve the trained model. Thereby, the feedback can be controlled.

In one embodiment, the method comprises determining a quality of the feedback message. The respective quality can be described by a quality index, e.g., a numeric value.

In another embodiment, it is decided depending on the quality of the feedback whether or not it will be used to train the existing trained model and to provide a feedback thereto. In a further embodiment, the reward, namely the reduction of the allocated amount is only given if the feedback as provided through the feedback message meets a certain quality criteria, e.g., the quality index is above a predefined threshold value.

The above given problem is also solved by a computer-readable medium with instructions for implementing at least one of the above-described methods when being executed by at least one processor. Similar advantages as described above are achieved.

Further, the problem is also solved by a system having a computer-readable medium as described above and/or a system for providing a chat conversation via text messages and/or audio messages. The respective system can comprise:
a chat application for providing at least one participant of the chat conversation, the chat application being adapted to determine and output responses to questions issued by at least one further participant of the chat conversation;
a trained model, in particular an autoregressive language model, preferably a deep learning model used by the software application to determine the responses;
a payment application:
   storing at least one client identity to identify the further participant and/or a client device used by the further participant;
   allocating an amount to be paid for the responses outputted by the chat application, preferably without concurrently requiring payment of the amount, using the client identity;
   monitoring a total allocated amount associated with the client identity;
   transmitting a payment request, the payment request for at least partially settling the total allocated amount associated with the particular client identity when the total allocated amount exceeds a predetermined threshold amount.

All of the above-mentioned components, namely the chat application, the payment application and the trained model can be part of a single software component or distributed in separate software components which themselves can be distributed across several computers and interact with each other as e.g., client server applications.

In an alternative embodiment, the payment request can be transmitted not only when the total allocated amounts exceeds a predetermined threshold amount, but also when the amount has been allocated for a time longer than a pre-set threshold, e.g., more than 1 week, more than 2 weeks, more than a month, more than 3 months, more than 6 months.

In one embodiment, the system in particular the payment application, does not consider the allocated amount but only the timeframe.

In one embodiment, the system may comprise a forecast application being adapted to determine costs for at least one of the responses. The respective determination can take one of the following parameters into consideration:
estimated electrical power for determining the response;
required electrical power actually consumed in determining the response;
estimated electrical power for at least partially determining the response;
required electrical power actually consumed in at least partially determining the response;
time to process;
priority of the request; and
amount of sources to be used to generate the answer.

In one embodiment, the forecast (additionally) depends on the load of the server that is determining the response. For example, there can be a weighting factor which leads to an up lift or down lift of the calculated cost, e.g., if the load is higher than average the costs will be increased by 20% (weighting factor=1.20). If it is lower than average costs will be decreased by 10% (weighting factor=0.90). Thereby the inventive system helps to distribute the load on the server(s) evenly over time. Load peaks are avoided which helps to establish a setting which has better average workload.

For estimating electrical power and/or calculation power, the system can provide adequate models which take into consideration electrical power consumption and/or required electrical power for responding to previous requests and/or for generating previous responses. Again, trained AI models can be used.

In one embodiment, the system comprises a training application for training the trained model, in particular the trained AI model for providing the response, based on feedback messages, wherein the payment application is adapted to reduce the allocated amount to be paid, if a feedback message received from the further participant is used to train the trained model. Again, the respective feedback can be used to improve the model. In one embodiment, the user can be provided with a credit which exceeds what the user has spent so far.

The above-given problem can also be solved by the use of a micropayment and/or fractional payment system to reduce the workload on a chat system. The respective chat system may comprise at least one trained model, in particular an autoregressive language model, preferably a deep learning model, for responding to questions issued in that chat system.

The respective usage provides similar effects and advantages as discussed above.

### BRIEF DESCRIPTION OF THE DRAWINGS

The invention will now be described in greater detail using several exemplary embodiments and making reference to the drawings, in which:

FIG. 1 shows a representative client device, chat system and payment system connected through the internet;

FIG. 2 shows several exemplary components of the payment system in accordance with FIG. 1;

FIG. 3 shows an exemplary data structure for the payment system in accordance with FIG. 2;

FIG. 4 shows an illustrative flow diagram of a method for providing a response to a client request, and

FIG. 5 shows several representative components of the chat system as captioned in FIG. 1.

In the following description, the same reference signs are used for the same and similarly acting parts.

### DETAILED DESCRIPTION

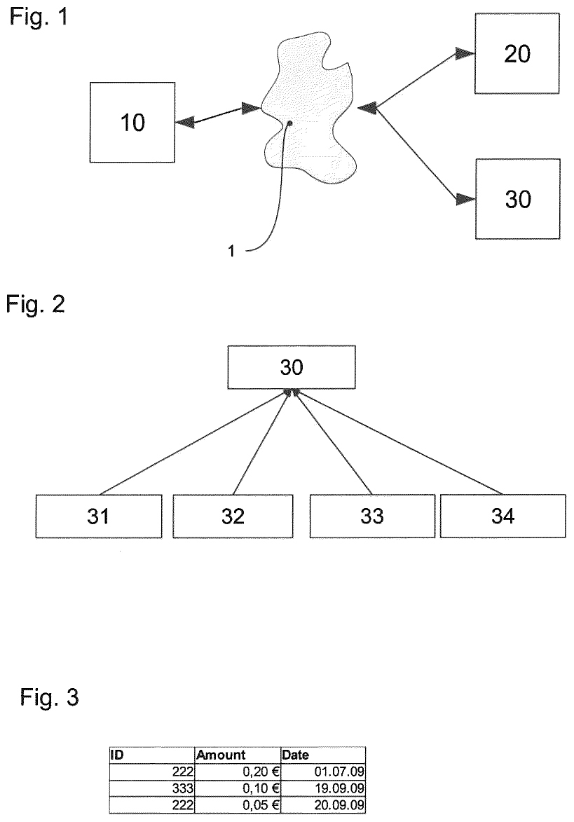

FIG. 1 shows a system according to the invention. A client device 10, for example, a laptop, a PC or a mobile terminal is connected via a network, in the present case the internet 1, to a chat system 20. The chat system 20 and the client device 10 are also in communicative connection, via the internet 1, with a payment system 30, preferably a payment system 30 to conduct micropayments. Normally, numerous other systems are connected to the internet 1.

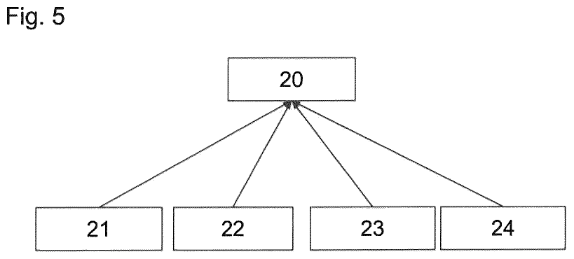

The chat system 20 can comprise a chat application 21 (FIG. 5) which can be a software program that allows users/participants to communicate with one another in real-time/near-time.

In one embodiment, the chat application 21 provides a customer service chatbot. The chatbot is designed to help customers with their queries or issues by providing automated responses. The chat system can be integrated with a company's website or mobile app, and used to handle customer queries, such as directing customers to the correct department for more complex issues.

In another embodiment the chatbot is designed in engaging in more sophisticated task, like helping to fill out customer forms or generating text for a damage report. Also, the chatbot can provide other services like generating sample code in a program language to solve a particular problem and/or generate individual letters for particular occasions which the user provides in a request to the chat application 21.

The chat application 21 can use a trained model 22 (FIG. 5) to generate the answers for a particular question provided by means of a request. In one embodiment, the trained model 22 is a large language model, e.g., a variant of the GPT (Generative Pre-trained Transformer) model. The training may be performed by a training application 23 which trains the model 22 on a massive amount of text data to generate human-like text. The chat application 21 can be adapted to be used for a wide range of natural language processing (NLP) tasks, such as text generation, language translation, and question answering.

In one embodiment, the chat application 21 is adapted to generate coherent and fluent text in a wide range of styles and formats. It can generate everything from creative writing to technical documentation, and can even mimic different writing styles and voices.

In one embodiment, the chat application 21 is adapted to understand and respond to context. The trained model 22 is trained on a large amount of text data such that covers a wide range of topics and styles, which allows it to understand the context of a given input and generate appropriate responses. This makes it a powerful tool for tasks such as question answering and dialogue generation.

In one embodiment, the chat application 21 and particularly the trained model 22 is fine-tuned for specific tasks and industries by training it on a smaller, domain-specific dataset. This allows for more accurate and relevant responses for specific use cases. For example, fine-tuning trained model 22 on a dataset of customer service inquiries can improve its ability to understand and respond to customer queries.

In one embodiment, the chat application 21 uses other technologies, such as voice recognition and text-to-speech systems integrated, to create more advanced and interactive applications, such as voice assistants.

In one embodiment, the chat application 21 is its integration in GPT-3. GPT-3 is an even more advanced version of GPT-2, which includes 175 billion parameters. This allows the chat application 21 to perform a wide range of language tasks without any fine-tuning, including language translation, summarization, question answering, and text completion. The respective implementation allows the chat application 21 to be used for content creation.

The front end of the chat application 21 can take many different forms, depending on the application and the platform it is being used on. In one embodiment, it is a web-based interface that allows users to input text into a text box and receive output in a separate text area.

Alternatively, the input can be gathered in a virtual reality or in an augmented reality environment. It can also be an app for a mobile device that allows users to input speech and receive output in the form of synthesized speech. Similarly, the response can be made available in virtual reality or in an augmented reality environment.

In one embodiment, the front end of the chat application 21 includes a number of features and functions to improve the user experience. For example, it includes a history of previous interactions, allowing users to easily refer back to previous conversations. It can also include features such as text formatting and the ability to attach images or other files.

The front-end of the chat application 21 can be built using different software technologies such as HTML, CSS, and JavaScript. These technologies are used to create an interactive and responsive web-based interface.

In one embodiment, the trained model 21 is trained on a massive amount of text data, which means that it has a large number of parameters. In one embodiment it might have around 100 billion parameters. It is obvious that the larger the trained model 21 is, the more calculation power is necessary to process the input and generate a response.

In one embodiment, the chat system 20 comprises a forecast application 24 to estimate the calculation power necessary to respond to a particular request.

The complexity of the input and task is also an important factor in determining the necessary power required to at least partially answer the request. The forecast application 24 can uses measured values of the past to forecast the required calculation power for a new request. The length of the question and the type can be taken into consideration.

It is one aspect of the invention, that the chat system 20 uses the payment system 30 to receive a compensation for the provided answers.

The payment system 30 comprises an identification device 31, an interface device 32 to allow communication with the chat system 20 and/or the client device 10, a memory device 33 and a processing device 34. Payment system 30 is a digital payment platform that can allow users to purchase any type of digital goods and services in a flexible and convenient way. The payment system 30 may also enable users to pay for digital content, such as online articles, e-books, music, and video games, without the need to enter their credit card details every time they make a purchase.

In one embodiment, the payment system 30 works by allowing users to create a potentially anonymous account, e.g., without any payment information like a credit card number, and then pre-authorize/allocates certain amounts of money, which can then be used to make purchases. This pre-authorized/allocated amount can be settled—at a later stage—with a credit card or other payment method. Thereby the payment system 30 significantly facilitates making small, incremental payments without having these amounts immediately debited to the preferred payment method.

In one embodiment, the payment system 30 is adapted to make purchases on any website that has integrated with the payment system 30. The authorization can be given by clicking on a “Put it on my tab” button or link, which will allocate the amount to be paid. Several embodiments of a usable payment system 30 are discussed EP 2476087B1 which is incorporated in its entirety by reference herein.

The payment system can be a digital payment platform that allows users to purchase digital goods and services in a flexible and convenient way, without the need of entering credit card details every time. It may allow users to pre-authorize a certain amount of money, which can then be used to make purchases and try out digital goods and services before committing to a purchase. The payment system may also provide a variety of tools for merchants to integrate the platform into their e-commerce systems.

FIG. 2 shows individual components of the payment system 30. The payment system 30 according to one embodiment of the invention has an identification device 31 for recording at least one identification number of the client device 10 or the user, an interface device 32 for receiving and confirming direct debit orders from the chat system 20 or any other merchant system, wherein the debit orders comprise information relating to an amount to be paid to the chat system 20 or any other system, a memory device 33 for storing the allocated amounts in conjunction with the associated identification numbers ID and a processing device 34 for processing the incoming requests.

In one embodiment, the payment system 30 is adapted to identify the user device 10 based purely on the MAC address. The memory device 33 thus stores the amount to be paid in conjunction with the corresponding MAC address. For this purpose, the payment system 30 comprises a corresponding database in which corresponding tables are kept. An exemplary extract from a table kept therein is shown in FIG. 3. Said table comprises, for example, three columns, specifically a first column which contains the identification of a client device 10 or a user, a second column which contains the amount to be debited and a third column which contains the date on which the direct debit order was received by the payment system 30. Each line of the table in FIG. 3 corresponds to a direct debit order. Thus, it is possible to read from the table in FIG. 3 that on Jul. 1, 2009, 20 Eurocents were debited/allocated for identification number 222. Furthermore, on Sep. 20, 2009, 5 Eurocents were debited for the same MAC address.

The processing device 34 can use these entries to determine the total payable from the debit amounts (allocated amount) for particular identification numbers ID. For example, the total payable for identification number 222 comes to 25 Eurocents.

Thus the payment system 30 can be configured, for example, so that a particular user has to settle his debts when they are greater than 0.29 Euro or 1 Euro or 10 Euro.

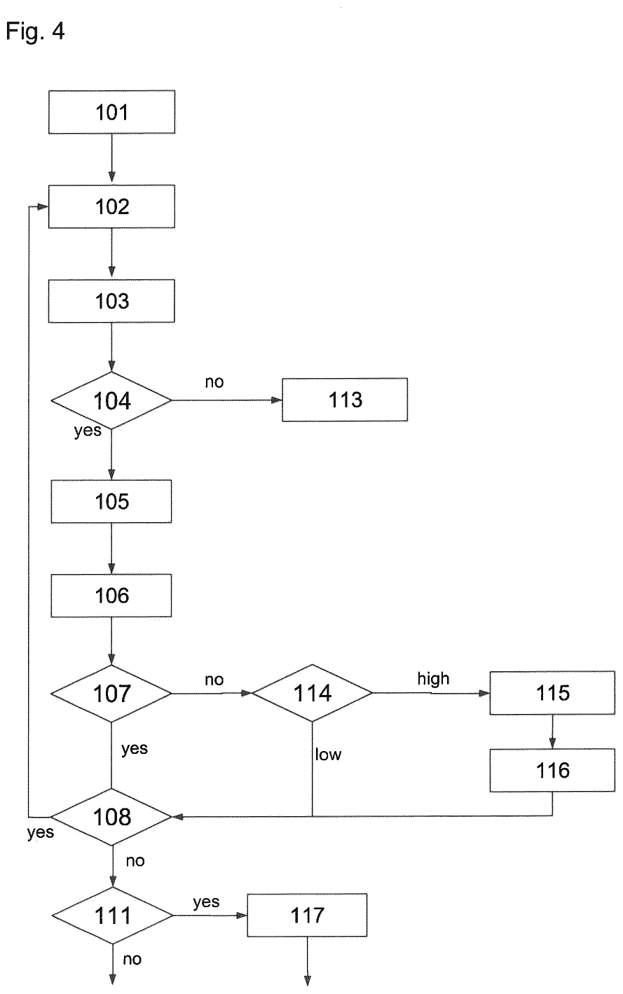

FIG. 4 describes one embodiment of an inventive process showing the interaction between the chat system 20 and the payment system 30. In Step 101 the identity of the user or participant in the chat application is determined. The respective determination process can be undertaken by the identification device 31 of the payment system 30 as previously described or by the chat system 20, e.g., the chat application 21. If the identification takes place on the side of the chat system 20, the respective identity or any other identity derived therefrom needs to be passed on to the payment system 30 for a later allocation of amounts with a particular user/participant.

In Step 102 the chat system, more precisely the chat application 21, receives a request from a user. Such a request could be to write an essay of 1500 words regarding the discovery of America.

In one embodiment, the forecast application 24 estimates the cost for responding to the request, e.g., by taking into consideration similar requests for writing an essay with that amount of words that have been answered previously. For doing so, the chat system 20 can log calculation power in relation to requests.

Alternatively or additionally, requests can be linked to certain amounts of energy consumption or other physical parameters required for performing the respective calculation. In one embodiment, the estimated costs are output to the user and the user is asked whether he is willing to bear the respective costs (Step 103). In Step 104 a response from the user is collected and it is determined whether the user authorizes the payment, e.g., by an authorization message. In Step 105, the chat system 20 may engage with the payment system 30, pass on the collected identity of the user and the costs for determining a response to the initial request. At that stage, the payment system 30 may allocate the respective amount of money for the particular user without requiring any immediate money transfer as previously discussed. In a not shown feedback step, the payment system 30 may confirm to the chat system 20 that the respective amount has been allocated. Under the condition that the payment system 30 confirms the respective transaction, the chat application 21 may output the response to the request in Step 106. For example, the complete essay containing around 1500 words may be transferred to the user.

In Step 107, the chat system 20 or the chat application 21 may invite the user to provide feedback on the received response. In one embodiment, such a feedback might just comprise a statement whether the response was satisfying or not. Alternatively, the response can be graded from very good to very poor, e.g., with different numeric values. In a (preferred) embodiment the user is enabled to provide feedback in a written form, e.g., “The essay is great, but you need to check your facts. Columbus arrived in America in 1492.” In such a situation the feedback from the user might be checked by the chat system in Step 114. Assuming that the quality of the feedback is high, the trained model 22, which has been used to generate the respective response, can be trained with the feedback (Step 115). The respective training can be performed online or offline.

In one embodiment, the feedback comprises a reference, e.g., an URI or URL, pointing to a resource verifying the correctness of the feedback.

If the quality of the feedback is high and was used for training or is intended to be used for training, the user can be offered a reward. Such a reward can be that the sum of allocated amounts stored by the payment system 30 will be reduced by a certain amount. For doing so, the chat system 20 once again interacts with the payment system 30, e.g., over the interface device 32, and informs the payment system about the identity of the user as well as the amount to be credited. In one embodiment, a credit can be assigned to the account that is linked to the identity.

If the user indicates in step 104 that he is not willing to pay for a response to the client request, the response might be denied in step 113. Alternatively, the user might be invited to compensate for the response by a different means, e.g., by watching a commercial and/or providing personal details and/or responding to a certain amount of questions.

In one embodiment, step 104 either encounters about the user's willingness to pay for the request and/or his willingness to watch a commercial and/or to perform any other action for compensation.

In one embodiment, the costs are calculated based on the amount of references necessary to determine the response and/or the amount of compensation that has to be paid to other users for using references (content/resources).

In the respective embodiment, the chat system 20, in particular the training application 23 might keep track of the resources that have been used for training the trained model 22. The system might offer a compensation for each of the references that have been used for the training. It is possible to statically compensate the respective references/reference providers, e.g., by providing these with microcredits/micropayments. The respective credit might simply depend on how much information the respective resource has provided.

In another embodiment, the compensation might be determined dynamically, e.g., by keeping track of the resources that have been used to generate a particular response. Again, the respective resources/resource provider can be rewarded with a fixed amount and/or with a dynamic amount that depends on the amount of information that was derived from the particular resource for the particular response.

In one embodiment, where the trained model 22 is a generative model using text blocks, each of the text blocks can be linked to one or several resources. Assuming that the respective text block is used for a response, the correlating resource can be compensated. With other generative (pre-trained) transformer models identifying the resources that triggered a particular response, might be significantly more difficult. Still, it is possible to make respective assessments and to assign proper compensation.

In the above discussed embodiments, compensation payments might be based on the user's willingness to pay for the use of the system. In another embodiment, the respective relationship might not exist. Again, a payment as discussed with regards to the payment system 30 might be used to provide the compensation to the particular resources.

In one embodiment, the authors of the respective resources might not be identifiable at the time of compensation and/or training. Thus, the system provides in one embodiment the option of claiming the compensation that has been anonymously accumulated for a particular resource. Claiming the respective compensation might involve providing proof that the content of the respective resource has been produced by the particular party (content provider) claiming the compensation.

Alternatively, if in Step 114 the quality of the feedback is assessed to be low, no reward might be offered. Instead, the user might be immediately taken into a dialog or scenario in which he can decide whether or not further requests are to be issued to the chat application 21. If so, the process will start again with Step 102, in which the chat application 21 receives another request.

In one embodiment, after finishing Step 108—no further questions—might be requested by the payment system to settle the allocated amounts, e.g., in Step 105, through a payment. In an alternative embodiment, as shown in FIG. 4, the payment system 30 will check whether the allocated amount exceeds a threshold value. If this is the case, the payment system 30 would invite the user to settle the allocated amounts. Otherwise, the user would be free to continue, e.g., by consuming other digital content or by returning to the chat system 20 at a later stage.

In one embodiment, the step 104 may comprise the option of receiving a day pass or any other pass that is limited by a certain amount of questions/client requests and/or a certain amount of time for which the system can be used. In one embodiment, responses are generated in an iterative process whereby the user gets to specify an initial question more precisely and/or amend the initial question. The cost estimate might cover several iterative cycles in which the question will be further defined or amended.

In another embodiment no cost estimates might take place in Step 104. The user could be invited to agree to the allocation of a certain amount after having received the response (after Step 106). The allocated amount can be based on a true measured consumption value (calculated and/or consumed electrical power) or on a fixed value. In yet another embodiment, the response might be delivered partially prior to allocating any amount for the response (Step 105). The second part might only be delivered once the allocation has taken place and/or the user has agreed to such an allocation.

Furthermore, in any of the above described embodiments, the check in accordance with Step 111 with or without the Step 117 might be performed at a much earlier point in time, e.g., immediately after Step 104. Thus, the “credit worthiness” (of the user) would be checked whenever the user indicates that he would be willing to pay for the respective response. In a situation in which the already allocated amount exceeds the threshold or meets other criteria for an immediate payment, the process could be interrupted until the user settles the allocated amount, e.g., in Step 117.

Also the inventive method might be implemented without the Step 107 and the following Steps 114, 115 and 116.

In the above captioned embodiments, there is a physical separation between the chat system 20 and the payment system 30. However, the invention can also be implemented without said physical separation. All necessary software components can be run on a single hardware. Also, in the above description different software components are named separately, e.g., the chat application 21, the training application 23, the forecast application 24. However, as part of the invention all of these components together with the necessary components for implementing the payment system 30 can be a single piece of software or separate in different software components depending on the implementation preference and/or other requirements imposed when implementing the respective systems 20, 30.

In accordance with the invention, an automated quality check of digital content can be implemented using a combination of natural language processing (NLP), techniques and machine learning (ML) algorithms. One possible approach would be to use NLP to extract features from the digital content, such as grammar, spelling, and readability. These features can then be fed into a ML model, such as a decision tree or a neural network, that has been trained on a dataset of high-quality and low-quality content. The model can then predict the quality of new content based on the features it extracts. Another approach would be to use pre-trained Language model such as GPT-3 to check the coherence, fluency, and structure of the digital content. Also, previous response and/or questions, the course of a chat communication can be taken into consideration.

In one embodiment, an automated quality check of digital content (Step 114) would be to cross-check the content at least partially against an existing database, such as Wikipedia, to ensure that the information provided is accurate and reliable. In one embodiment, this could be done again using NLP techniques to extract key entities and concepts from the digital content provided (feedback), and then comparing them to the corresponding entries in the database.

For example, the system could identify named entities, such as people, places, dates and organizations, and then check if they exist in Wikipedia, potentially in the same context as used in the chat conversation. It could also extract key concepts and check if they are correctly defined and used in context. If the system finds any discrepancies or errors, it could flag the content as potentially low-quality.

Additionally, the system could use sentiment analysis to check the tone and sentiment of the content, to ensure that it is appropriate and not offensive or biased.

Finally, the system could be designed to be adaptive and improve over time by continuously learning from the feedback provided by human editors who evaluate the feedback.

The payment system 30 might be adapted to handle payments of fiat and/or virtual currencies. The payments might be micropayments and/or fractional payments.

Furthermore, as already discussed above, step 117 might offer alternatives to a true payment (in a virtual or fiat currency), e.g., the user can be requested to perform certain actions as already discussed above to compensate for the allocated amount.

At this point, it should be noted that all of the parts described above are claimed to be relevant to the invention when considered alone and in any combination, especially of the details shown in the drawings.

### REFERENCE SIGNS

1 Internet
10 client device
20 Chat system
21 Chat application
22 Trained model
23 Training application
24 Forecast application
30 Payment system
31 Identification device
32 Interface device
33 Memory device
34 Processing device
ID Identification number
101 Step 101: Determine identity of participant
102 Step 102: Receiving request
103 Step 103: Estimating costs for responding to the request
104 Step 104: Is participant willing to pay for the request
105 Step 105: Allocating an amount for the response
106 Step 106: Generating and outputting a response
107 Step 107: Is the participant satisfied with the response
108 Step 108: Further questions?
111 Step 111: allocated amount exceeding threshold?
113 Step 113: Deny response
114 Step 114: Check quality of the feedback
115 Step 115: Train model with feedback
116 Step 116: Reduce allocated amount
117 Step 117: Initiating payment

1. A method for providing a response to a client request comprising the steps of:
a) Receiving a client request over an interface from a client device, the client request being in the form of at least one of an image, text, audio and video data;
b) Determining a client identity of a user issuing the request and/or the client device;
c) Determining cost for responding to the request by querying a trained artificial intelligence model, wherein the cost is based on a as a function of electrical power consumption by the trained artificial intelligence model;
d) Transmitting a cost indication to the client device based at least in part on the determined costs;
e) Determining the response to the client request using the trained artificial intelligence model;
f) Transmitting the response to the client device;
g) Allocating an amount to be paid for the transmission of the response to the client device, with or without concurrently requiring payment of the amount, using the client identity, wherein the amount is based at least in part on the cost indication;
h) Monitoring a total allocated amount associated with the client identity; and
i) Transmitting a payment request, wherein the payment request is for at least partially settling the total allocated amount associated with the client identity when the total allocated amount exceeds a predetermined threshold amount.

2. The method of claim 1, wherein the determination of cost in step c is based at least in part on a forecast calculation of at least one of estimated or required electrical power for the trained artificial intelligence model to determine at least one of (i) a response to the request, and (ii) a partial response to the client request.

3. The method of claim 1, comprising the steps of:
j) Receiving an authorisation signal, the authorisation signal indicating that the user of the client device is accepting to allocate an amount that correlates to the cost indication for receiving the response to the client request.

4. The method of claim 1, wherein step is performed after the step.

5. The method of claim 1, comprising the steps of:
j) Receiving an authorisation signal, the authorisation signal indicating that the user of the client device is accepting to allocate an amount that correlates to the cost indication for receiving the response to the client request.

6. The method of claim 5, wherein step f comprises:
transmitting a first part of the response and transmitting at least a second part of the response,
wherein the step is performed prior to transmitting the second part of the response and/or wherein the second part of the response is only transmitted if the authorisation signal in accordance with step j) is received.

7. The method of claim 5, comprising the steps of:
k) receiving a further client request over the interface from the client device;
l) determining whether a further authorisation signal is received, the further authorisation signal indicating that the user of the client device is accepting to allocate a further amount for a further response; and
m) transmitting a further response to the client device, only if it is determined in step l) that the authorisation signal has been received.

8. The method of claim 1, comprising the step of:
n) issuing at least one invitation message offering a reward for feedback on the provided receiving a message from the client device,
o) receiving a feedback message from the client device on the response as transmitted in step f;
p) using the feedback message to train the trained model; and
q) reducing the allocated amount to be paid in response to receiving the feedback message.

9. The method of claim 8, further comprising the step of determining a quality index of the feedback message, wherein for a particular feedback message, at least one of the steps p) and q) are only performed if the quality index meets a pre-set criteria with respect to a predefined threshold value.

10. A system for providing an artificial intelligence-based chat conversation with at least one participant via at least one of image, text, audio and video messages, comprising:
at least one processor for executing:
a chat application for providing at least one participant of the chat conversation, wherein the chat application is adapted to determine and transmit output responses to questions issued by at least one further participant of the chat conversation;
a trained artificial intelligence model application used by the chat application to determine the responses; and
a payment application that is adapted to:
store at least one client identity to identify at least one of the further participant and a client device used by the further participant;
allocate an amount to be paid for the responses to be transmitted by the chat application, with or without concurrently requiring payment of the amount in connection with the at least one client identity;
monitoring a total allocated amount associated with for a particular one of the at least one client identity; and
transmitting a payment request for at least partially settling the total allocated amount associated with the particular one of the at least one client identity when the total allocated amount exceeds a predetermined threshold amount.

11. The system according to claim 10, wherein the at least one processor is for further executing:
a forecast application adapted to determine costs for at least one of the response based at least in part on:
an estimated electrical power consumption for determining the response;
a required electrical power actually consumed in determining the response;
an estimated electrical power consumption for at least partially determining the response; and
a required electrical power actually consumed in at least partially determining the response.

12. The system according to claim 10, wherein the at least one processor is for further executing:
a training application for training the trained artificial intelligence model application based on feedback messages, wherein the payment application is adapted to reduce the allocated amount to be paid if a feedback message received from the further participant is used to train the trained model.

13. The system according to claim 10, wherein the trained artificial intelligence model application employs at least one of an autoregressive language model, and a deep learning model.
